(19) United States
(12) Patent Application Publication
(10) Pub. No.: US 2026/0231110 A1
(43) Pub. Date: Aug. 6, 2026

(54) METHODS TO CONVEY THE ENVIRONMENT TYPE KNOWLEDGE TO ASSIST IN RADIO SIGNAL BASED SENSING

(71) Applicant: Telefonaktiebolaget LM Ericsson (publ), Stockholm (SE)

(72) Inventors: Ritesh Shreevastav, Upplands Väsby (SE); Iana Siomina, Täby (SE)

(21) Appl. No.: 19/150,398

(22) PCT Filed: Feb. 14, 2024
(86) PCT No.: PCT/IB2024/051392

§ 371 Date: Jul. 23, 2025

Related U.S. Application Data
(60) Provisional application No. 63/484,862, filed on Feb. 14, 2023.

(51) Int. Cl. H04W 64/00; G01S 13/42; G01S 13/58

(52) U.S. Cl. CPC H04W 64/006; G01S 13/42; G01S 13/58

(57) ABSTRACT

Systems and methods are disclosed for conveying environment information to assist in radio signal based sensing using a cellular network. In one embodiment, a method performed by a first node for conveying environmental information to assist in radio-signal-based sensing using a cellular network comprises obtaining environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object. The method further comprises providing the environment information to a second node associated with the radio-signal-based sensing or involved in a radio-signal-based sensing session. In this manner, using the environment information for sensing becomes possible.

### RELATED APPLICATIONS

This application claims the benefit of provisional patent application Ser. No. 63/484,862, filed Feb. 14, 2023, the disclosure of which is hereby incorporated herein by reference in its entirety.

### TECHNICAL FIELD

The present disclosure relates to radio-signal based sensing of non-connected objects in a cellular communications network.

### BACKGROUND

Sensing herein is a radio-signal based sensing operation comprising one or more sensing related procedures, where a sensing procedure is performed in order to contribute to obtaining one or more sensing results. A sensing procedure can be any of: obtaining a sensing result, transmitting a radio signal to enable a sensing measurement, receiving a radio signal for obtaining a sensing measurement or other sensing result, performing a radio measurement for sensing, exchanging the information (e.g., sensing data, assistance data, measurements) to enable or facilitate obtaining a sensing result, etc.

Sensing using cellular networks can be performed in a monostatic setting when transmitter and receiver sensing antennas are located in the same node and in a multi-static setting when the transmitter and receiver sensing antennas are located in different nodes.

### SUMMARY

Systems and methods are disclosed for conveying environment information to assist in radio signal based sensing using a cellular network. In one embodiment, a method performed by a first node for conveying environmental information to assist in radio-signal-based sensing using a cellular network comprises obtaining environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object. The method further comprises providing the environment information to a second node associated with the radio-signal-based sensing or involved in a radio-signal-based sensing session. In this manner, using the environment information for sensing becomes possible.

In one embodiment, the environment associated to the sensing target or sensing area is an environment associated with the first node.

In one embodiment, the sensing object is an object that is not connected to the cellular network.

In one embodiment, the environment information comprises location information of the first node.

In one embodiment, the environment information comprises: (a) environment type, (b) sensing radio environment quality, (c) radio propagation characteristics, (d) knowledge level about the environment, (e) environment information quality or reliability level, (f) environment information actuality, (g) speed of the sensing target or the first node, (h) velocity or movement direction of the sensing target or the first node, (i) statistical characteristic, statistical data or a function of one or more environment information parameters or characteristics listed in (a)-(h), or (j) a combination of any two or more of (a)-(i). In one embodiment, the environment information further comprises one or more of the following: (i) location information about a location of the environment associated to the sensing target or sensing area, (ii) time associated with the environment information, (iii) validity time for the environment information, or (iv) a combination of any two or more of (i)-(iii).

In one embodiment, obtaining environment information comprises determining the environment information based on any one or more of: radio measurements, radio channel estimation result, physical sensor measurements, a map, a mapping function, a table, a location, historical data, statistics, observation data, or a combination of any two or more thereof.

In one embodiment, obtaining environment information comprises determining the environment information based on any one or more of: radio measurements, radio channel estimation result, physical sensor measurements, a map, a mapping function, a table, a location, historical data, statistics, observation data, or a combination of any two or more thereof.

In one embodiment, obtaining environment information comprises determining the environment information based on a message or indication received from another node.

In one embodiment, obtaining environment information comprises determining or building the environment information, based on one or more sensing results.

In one embodiment, obtaining environment information comprises determining or building the environment information, based on one or more sensing results, jointly with another radio node. In one embodiment, determining or building the environment information, based on one or more sensing results, jointly with another radio node, comprises: performing sensing over a first part of the environment to thereby obtain sensing results for the first part of the environment, receiving sensing results for a second part of the environment from a second node, and combining the sensing results for the first part of the environment and the sensing result received from the second node for the second part of the environment to provide the environment information. In another embodiment, determining or building the environment information, based on one or more sensing results, jointly with another radio node, comprises requesting that a second node verify the environment information.

In one embodiment, providing the environment information to the second node comprises providing the environment information to the second node via a sensing request, a sensing result request, a response to a sensing-related request or configuration message from the second node, sensing assistance information, a sensing configuration message, an information message associated to sensing, a validate request associated to sensing, or an aggregated or differential result message associated to sensing.

In one embodiment, the method further comprises receiving a request for the environment information from the second node.

In one embodiment, the method further comprises receiving one or more sensing results from another node, in response to providing the environment information to the second node.

In one embodiment, the first node is a User Equipment (UE), and the second node is a network node. In one embodiment, the environment is an environment of the UE.

In one embodiment, the first node is a first UE, and the second node is a second UE. In one embodiment, the environment is an environment of the first UE.

In one embodiment, the first node is a first network node and the second node is a second network node.

In one embodiment, the first node is a network node and the second node is a UE.

In one embodiment, the first node comprises a sensing client or sensing application.

In one embodiment, the first node comprises a sensing unit further comprising one or both of: transmitter transmitting a radio signal for sensing and receiver receiving a radio signal for sensing or performing a sensing measurement.

Corresponding embodiments of a first node are also disclosed. In one embodiment, a first node for conveying environmental information to assist in radio-signal-based sensing using a cellular network is adapted to obtain environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object. The first node is further adapted to provide (204) the environment information to a second node associated with the radio-signal-based sensing or involved in a radio-signal-based sensing session.

In another embodiment, a first node for conveying environmental information to assist in radio-signal-based sensing using a cellular network comprises processing circuitry configured to cause the first node to obtain environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object. The processing circuitry is further configured to cause the first node to provide the environment information to a second node associated with the radio-signal-based sensing or involved in a radio-signal-based sensing session.

Embodiments of a method performed by a second node for radio-signal-based sensing using a cellular network are also disclosed. In one embodiment, a method performed by a second node for radio-signal-based sensing using a cellular network comprises obtaining, from a first node, environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object. The method further comprises using the environment information for radio-signal based sensing of the sensing target or sensing area.

In one embodiment, the environment associated to the sensing target or sensing area is an environment associated with the first node.

In one embodiment, the sensing object is an object that is not connected to the cellular network.

In one embodiment, the environment information comprises location information of the first node.

In one embodiment, the environment information comprises: (a) environment type, (b) sensing radio environment quality, (c) radio propagation characteristics, (d) knowledge level about the environment, (e) environment information quality or reliability level, (f) environment information actuality, (g) speed of the sensing target or the first node, (h) velocity or movement direction of the sensing target or the first node, (i) statistical characteristic, statistical data or a function of one or more environment information parameter or characteristic listed above, or (j) a combination of any two or more of (a)-(i). In one embodiment, the environment information further comprises one or more of the following: (i) location information about a location of the environment associated to the sensing target or sensing area, (ii) time associated with the environment information, (iii) validity time for the environment information, or (iv) a combination of any two or more of (i)-(iii).

In one embodiment, using the environment information for radio-signal based sensing comprises: (I) configuring one or more parameters for a sensing session based on the environment information, (II) configuring one or more sensing units based on the environment information, (III) providing the environment information to one or more sensing units, (IV) choosing one or more configurations for sensing, based on the environment information, (V) sending the environment information or a chosen configuration based on the environment information to another node, (VI) obtaining at least one sensing result or sensing measurement result, or (VII) a combination of any two or more of I-VI.

In one embodiment, the method further comprises providing a sensing result to another node.

In one embodiment, the second node is a network node.

In one embodiment, the second node is a first UE.

Corresponding embodiments of a second node are also disclosed. In one embodiment, a second node for radio-signal-based sensing using a cellular network is adapted to obtain, from a first node, environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object. The second node is further adapted to use the environment information for radio-signal based sensing of the sensing target or sensing area.

In another embodiment, a second node for radio-signal-based sensing using a cellular network comprises processing circuitry configured to cause the second node to obtain, from a first node, environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object. The processing circuitry is further configured to cause the second node to use the environment information for radio-signal based sensing of the sensing target or sensing area.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the different radar settings that can be deployed using cellular base stations;

FIG. 2 is a flow chart that illustrates the operation of a first node in accordance with an embodiment of the present disclosure;

FIG. 3 is a flow chart that illustrates the operation of a second node in accordance with an embodiment of the present disclosure;

FIGS. 4, 5, 6, 7, and 8 illustrate non-limiting example implementations, based on the methods described herein;

FIG. 9 shows an example of a communication system in accordance with some embodiments;

FIG. 10 shows a User Equipment (UE) in accordance with some embodiments;

FIG. 11 shows a network node in accordance with some embodiments;

FIG. 12 is a block diagram of a host, which may be an embodiment of the host of FIG. 9, in accordance with various aspects described herein;

FIG. 13 is a block diagram illustrating a virtualization environment in which functions implemented by some embodiments may be virtualized; and

FIG. 14 shows a communication diagram of a host communicating via a network node with a 1406 over a partially wireless connection in accordance with some embodiments.

### DETAILED DESCRIPTION

The embodiments set forth below represent information to enable those skilled in the art to practice the embodiments and illustrate the best mode of practicing the embodiments.

Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

### 1 Terminology

The following terminology is used herein.

The term “environment” as used herein is, e.g., a physical environment, radio environment, or a combination of the two. The environment may be further associated herein with specific radio propagation properties. See Section 3 below for more details on environment information.

A “sensing result” or “sensing information” comprises, e.g., one or more of:
sensing measurements,
a result of processing sensing measurements to achieve a sensing purpose.

Sensing measurements are radio measurements used to achieve a sensing purpose. Sensing measurements can be layer 1 (L1), layer 2 (L2), or layer (L3) measurements or a function of them, e.g., timing measurements (e.g., Time of Arrival (TOA), Relative TOA (RTOA), Receive (Rx)-Transmit (Tx) time difference, Round-Trip Time (RTT), timing advance, Time Difference of Arrival (TDOA), propagation delay, delay spread, etc.), received power or signal quality (e.g., Received Signal Strength Indicator (RSSI), Reference Signal Received Power (RSRP), Reference Signal Received Quality (RSRQ), Signal to Interference plus Noise Ratio (SINR), Es/Iot (i.e., ratio of received energy per resource element(Es) over receiver power spectral density of the total noise and interference for a certain resource element (Iot)), L1-RSRP, L1-RSRQ, power distribution, etc.), pathloss, angle measurements (angle of arrival, angle of departure), timing of one or more correlation peaks, average/median/distribution of a plurality of sensing measurements, channel state estimation, etc.

“Sensing purpose” is, e.g., any of:
identifying presence or absence of a sensing target object or obstacles,
identifying characteristics of a sensing target object (e.g., size, type of object, type of material, movement, etc.),
recognition of a sensing target object or obstacles,
identification or characterizing physical environment state (e.g., weather, busy hours, activity level in an area, environment change compared to a reference state, etc.),
creating/(re)generating/updating a map, based on sensing results.

“Sensing target” is an area or an object with respect to which the sensing purpose is to be achieved. Sensing target can be an area or one or more objects. “Sensing area” is an area where sensing is performed.

The term “signal” or “radio signal” as used herein is any physical signal or physical channel. Physical signal may also be called reference signals (RS). Examples of downlink (DL) physical signals are DL signals used for sensing, synchronization signals, Primary Synchronization Signal (PSS), Secondary Synchronization Signal (SSS), Channel State Information (CSI) Reference Signal (CSI-RS), Demodulation Reference Signal (DMRS), signals in a Synchronization Signal Block (SSB), discovery reference signals (DRS), Cell-specific RS (CRS), positioning signals, Positioning Reference Signal (PRS), tracking signals, Tracking Reference Signal (TRS), Radio Link Monitoring (RLM) signals, RLM-RS, beam management signals, Beam Failure Detection (BFD)-RS, Beam Management (BM)-RS, etc. Examples of uplink (UL) physical signals are UL signals used for sensing, Sounding Reference Signal (SRS), DMRS, etc. RS may be periodic, e.g., RS occasion carrying one or more RSs may occur with certain periodicity, e.g. 20 milliseconds (ms), 40 ms, etc. The RS may also be aperiodic. Each SSB carries New Radio (NR)-PSS, NR-SSS, and NR-Physical Broadcast Channel (PBCH) in four successive symbols. One or multiple SSBs (also referred to as SS/PBCH blocks) are transmitted in one SSB burst which is repeated with certain periodicity, e.g. 5 ms, 10 ms, 20 ms, 40 ms, 80 ms, and 160 ms. The User Equipment (UE) is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset with respect to a reference time (e.g., serving cell's System Frame Number (SFN)), etc. Therefore, SMTC occasion may also occur with certain periodicity, e.g. 5 ms, 10 ms, 20 ms, 40 ms, 80 ms, and 160 ms. The SMTC occasion may contain one or more RSs such as SSBs. The term physical channel refers to any channel carrying higher layer information, e.g. data, control etc. Examples of physical channels are data channel, control channel, PBCH, Narrowband PBCH (NPBCH), Physical Downlink Control Channel (PDCCH), Physical Downlink Shared Channel (PDSCH), Physical Uplink Control Channel (PUCCH), Physical Uplink Shared Channel (PUSCH), short PUCCH (sPUCCH), short PDSCH (SPDSCH), short PUCCH (sPUCCH), short PUSCH (sPUSCH), Machine Time Communication (MTC) PDCCH (MPDCCH), Narrowband PDCCH (NPDCCH), Narrowband PDSCH (NPDSCH), Enhanced PDCCH (E-PDCCH), Narrowband PUSCH (NPUSCH), etc.

The non-limiting term “network node” can comprise any of: sensing unit or node, sensing server, sensing management function, Sensing Management Function (SeMF), sensing processing function, Sensing Processing Function (SPF), physical network node, logical network node, radio network node, base station (BS), NR base station, multi-standard radio (MSR) radio node such as MSR BS, sensor node, NodeB, eNodeB, gNodeB, Master eNB (MeNB), Secondary eNB (SeNB), access point, network controller, radio network controller (RNC), base station controller (BSC), base transceiver station (BTS), Central Unit (e.g. in a gNB), Distributed Unit (e.g. in a gNB), Baseband Unit, Centralized Baseband, C-RAN, access point (AP), transmission points, transmission nodes, transmission point or TP, reception point or RP, transmission reception point (TRP), Remote Radio Unit (RRU), Remote Radio Head (RRH), nodes in distributed antenna system (DAS), core network node (e.g. MSC, MME, Access and Mobility Management Function (AMF), Session Management Function (SMF), Network Exposure Function (NEF), etc.), Operations, Administration, and Maintenance (OAM) node, OSS, SON, etc.

The non-limiting term “UE” refers to any type of wireless device communicating with a network node and/or with another UE in a cellular or mobile communication system. Examples of UE are mobile device, target device, sensing device, device to device (D2D) UE, vehicular to vehicular (V2V), machine type UE, MTC UE or UE capable of machine to machine (M2M) communication, Personal Digital Assistant (PDA), tablet, mobile terminals, smart phone, laptop embedded equipment (LEE), laptop mounted equipment (LME), Universal Serial Bus (USB) dongles, etc.

“Sensing unit” comprises a radio network unit or node capable of at least one of: transmitting radio signals for sensing, receiving radio signals for sensing, processing of radio signals for sensing, performing sensing measurements, etc. A sensing unit may be equipped with one or more internal or external antennas or may share antennas with other nodes (e.g., with BS or gNB). The sharing may be, e.g., via antenna sharing combiner or coupler. A sensing unit may be a standalone node, may be integrated into a BS or another radio network node, may be co-located with another radio network node, or may be co-sited with another radio network node. Examples of sensing units: transmission point (TP), reception point (RP), transmission and reception point (TRP), a functional block or unit, a base station, gNB, a radio network node.

“Sensing server” comprises a software and/or hardware entity that interacts with a sensing client for the purpose of providing sensing results. Sensing server can comprise a UE or a network node. Sensing server may provide one or more sensing results to a sensing client.

“Sensing client” comprises a software and/or hardware entity that interacts with a sensing server or sensing management function for the purpose of obtaining sensing results. Sensing clients may need to subscribe to sensing service in order to obtain sensing results. Sensing client can comprise a UE or a network node. A sensing client may send a sensing request to the sensing server or sensing management function and receive sensing results in response to its sensing request.

### 2 Introduction

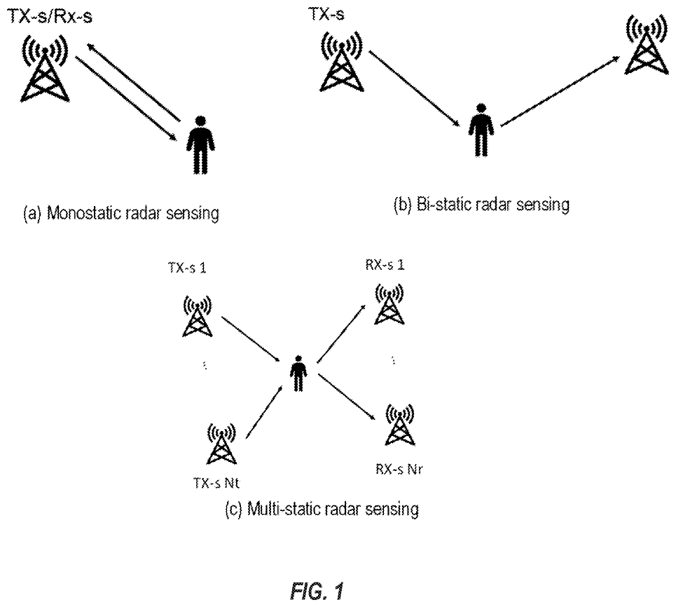

FIG. 1 illustrates the different radar settings that can be deployed using cellular base stations. The goal is to detect and localize a target which is, in general, an object that is not connected to the network (e.g., a pedestrian, an animal, etc.). As illustrated in FIG. 1(a), the monostatic setting refers to the setting for which the transmit sensing antenna array, denoted by TX-s, is co-located at the same node (here, the same base station) as the receiver sensing antenna array, denoted by RX-s. As illustrated in FIG. 1(b), the bi-static setting corresponds to the case where the transmit sensing array antennas TX-s is located at a different node as compared to the receiver sensing antennas RX-s. Finally, as illustrated in FIG. 1(c), multi-static setting corresponds to the case for which several TX-s and several RX-s are present and they are all located at different nodes (base stations here).

There currently exist certain challenge(s) with respect to sensing in a cellular communications network. Currently, there is no environment type indication enhancing radio signal-based sensing. However, an environment type indication would be very beneficial to adapt sensing configuration and sensing procedure, which can be used to improve sensing result and optimize sensing configuration to enable more resource-efficient sensing.

Certain aspects of the disclosure and their embodiments may provide solutions to these or other challenges. The present disclosure comprises at least the following embodiments.

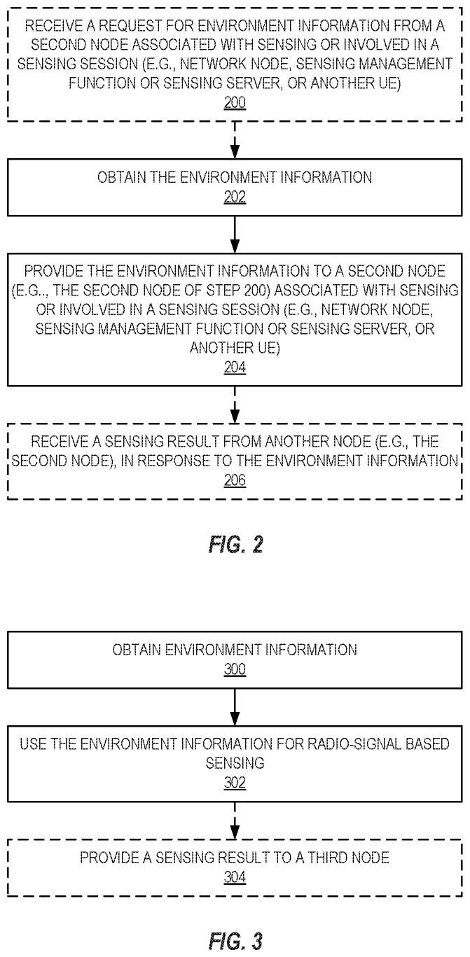

Embodiments of a method in a first node (e.g., User Equipment (UE), sensing client, sensing unit, sensing server, Operations, Administration, and Maintenance (OAM) node, or another network node) are disclosed. As illustrated in FIG. 2, in one embodiment, the method in the first node comprises the following:
Step 200 (in some, but not necessarily all, embodiments): The first node receives a request for environment information from a second node associated with sensing or involved in a sensing session (e.g., network node, sensing management function or sensing server, or another UE).
Step 202: The first node obtains the environment information.
Step 204: The first node provides the environment information to the second node associated with sensing or involved in the sensing session (e.g., network node, sensing management function or sensing server, or another UE) to assist in radio-signal based sensing.
   In some examples, the first node can further receive a confirmation or acknowledgement from the second node of reception of an indication or message comprising the environment information from the first node (the indication or message may or may not comprise other information, in addition to the environment information).
Step 206 (in some, but not necessarily all, embodiments): The first node receives a sensing result from another node (e.g., the second node), in response to the message comprising the environment information.

See Section 1 above for the terms “sensing client”, “sensing server”, “network node”, and “UE”. Further details regarding the steps of the method of FIG. 2 are provided below in Section 3.

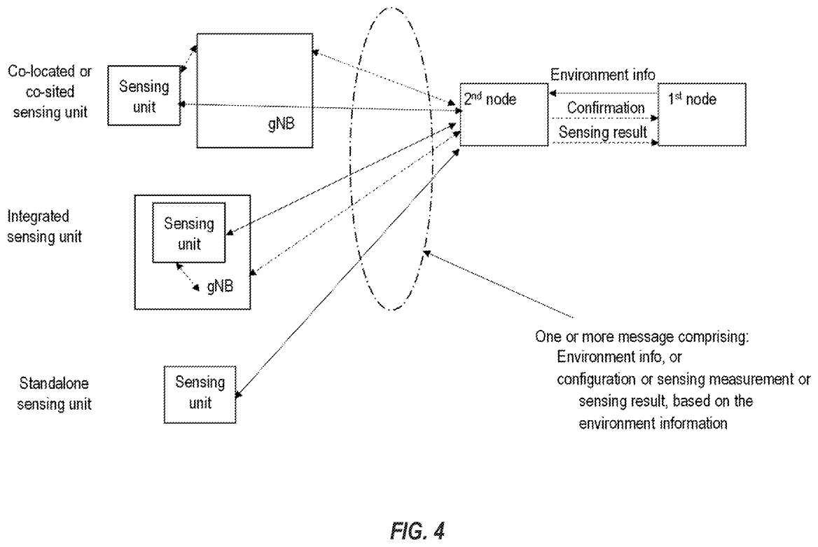

Embodiments of a method in the second node (e.g., a network node, sensing management function or sensing server, sensing unit, etc.) are also disclosed. As illustrated in FIG. 3, the method in the second node comprises the following:
Step 300: The second node obtains environment information (e.g., from the first node as in, e.g., steps 200 and 204).
   In some examples, the obtaining further comprises receiving the environment information from a first node (see Section 3 below) or from another network node, sensing management or control function or sensing server, sensing unit, etc.
   In some examples, the obtaining further comprises sending to the first node a confirmation or acknowledgement of reception of an indication or message comprising environment information from the first node (the indication or message may or may not comprise other information, in addition to the environment information).
Step 302: The second node uses the environment information for radio-signal based sensing (e.g., choosing or configuring one or more parameters for a sensing session, configuring sensing units, providing the obtained sensing information to one or more sensing units, etc.).
Step 304 (in some, but not necessarily all, embodiments): The second node provides a sensing result to a third node (e.g., UE, sensing client, sensing management function, Sensing Management Function (SeMF), sensing server, OAM, positioning node, Enhanced Serving Mobile Location Center (ESMLC), or another network node) or another network node), wherein the sensing result is based on the environment information.

Further details regarding the steps of the method of FIG. 2 are provided below in Section 4 below.

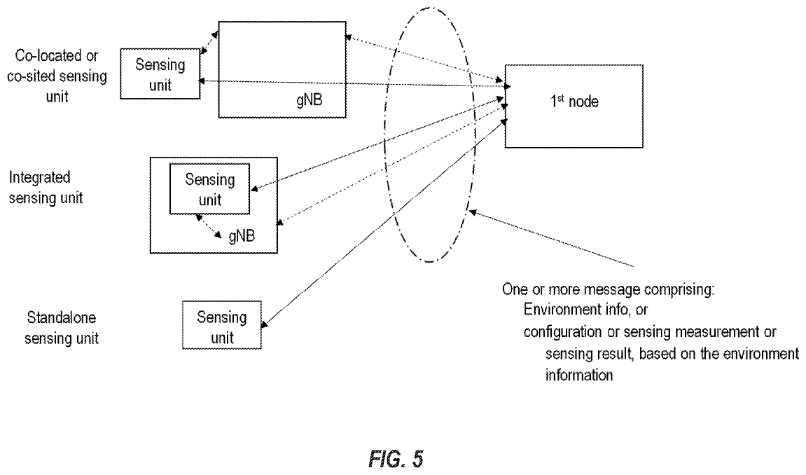

FIGS. 4, 5, 6, 7, and 8 illustrate non-limiting example implementations, based on the methods described herein.

In particular, FIG. 4 illustrates a first example implementation. Note that, in the integrated and co-located/co-sited cases, there can be an additional interface between sensing unit and gNB, and the gNB may receive and forward/send to sensing unit. Not all of the sensing unit deployment cases (co-located/co-sited/integrated/standalone) may be present. The first and second nodes are as described with respect to the methods in the first node (see Section 3 below) and the methods in the second node (see Section 4 below).

FIG. 5 illustrates a second example implementation. Note that, in the integrated and co-located/co-sited cases, there can be an additional interface between sensing unit and gNB, and gNB may receive and forward/send to sensing unit. Not all of the sensing unit deployment cases (co-located/co-sited/integrated/standalone) may be present. The first and second nodes are as described with respect to the methods in the first node (see Section 3 below) and the methods in the second node (see Section 4 below).

FIG. 6 illustrates a third example implementation. In this example, environment information is sent from a sensing client to a sensing server or sensing management function.

The sensing server or sensing management function may optionally send a confirmation to the sensing client. In addition, after sensing is performed, the sensing server or sensing management function may optionally send a sensing result to the sensing client.

FIG. 7 illustrates a fourth example implementation. The first and second nodes are as described with respect to the methods in the first node (see Section 3 below) and the methods in the second node (see Section 4 below). As illustrated, a gNB A1 or sensing unit A2 sends environment information to the second node as described herein. The second node sends the environment information or a configuration based on the environment information to a sensing unit B. The sensing unit B may optionally send sensing measurements or a sensing result to the second node. The second node may optionally send a confirmation of receipt of the environment information to the gNB A1 or sensing unit A2. The second node may optionally send a configuration based on the environment information to gNB A1 or sensing unit A2. The gNB A1 or sensing unit A2 may return sending measurements or a sensing result to the second node.

FIG. 8 illustrates a fifth example implementation. In this example, an OAM or anchor node sends environment information to a sensing server or sensing management function. The sensing server or sensing management function may optionally return a confirmation to the OAM or anchor node.

Certain embodiments may provide one or more of the following technical advantage(s):
Obtaining and using the environment information for sensing becomes possible.
UE and network (NW) sharing the responsibility of sensing the environment together and combining the results or evaluating the differences and further validating the result.
Sensing signal transmission can be made dynamic based upon environment information. It can adapt to the changes in the environment.
Several different use cases which rely upon environment info can be realized such as autonomous driving, UAV detection.

### 3 Methods in a First Node

Embodiments of a method in a first node (e.g., UE, sensing client, sensing unit, OAM or another network node) are disclosed. As illustrated in FIG. 2, in one embodiment, the method in the first node comprises the following:
Step 200 (in some, but not necessarily all, embodiments): The first node receives a request for environment information from a second node associated with sensing or involved in a sensing session (e.g., network node, sensing management function or sensing server, or another UE).
Step 202: The first node obtains the environment information.
Step 204: The first node provides the environment information to the second node associated with sensing or involved in the sensing session (e.g., network node, sensing management function or sensing server, or another UE) to assist in radio-signal based sensing.
   In some examples, the first node can further receive a confirmation or acknowledgement from the second node of reception of an indication or message comprising the environment information from the first node (the indication or message may or may not comprise other information, in addition to the environment information).
Step 206 (in some, but not necessarily all, embodiments): The first node receives a sensing result from another node (e.g., the second node), in response to the message comprising the environment information.

See Section 1 above for the terms “sensing client”, “sensing server”, “network node”, and “UE”. Further details regarding each of the steps of the method of FIG. 2 are provided in the subsections below.

### 3.1 Step 200 (in Some, But Not Necessarily All, Embodiments): Receiving a Request for Environment Information

This step may not be present in all implementations.

In this step, the first node receives a request for environment information from a second node associated with sensing or involved in a sensing session (e.g., from network node, sensing management function or sensing server, or another UE).

3.2 Step 202: Obtaining the Environment Information The first node (e.g., UE, sensing client, sensing server, OAM or another network node) obtains the information associated with the environment of a sensing target (e.g., an area or an object), e.g., by one or more of:
Determining the environment information based on any one or more of:
   radio measurements or channel estimation result (e.g., determining radio propagation characteristics, link quality, velocity data, single or multiple peak detection, or location based on pathloss estimation, Line-of-Sight (LOS)/Non-LOS (NLOS) detection, timing measurements, angle measurements, received power measurements, doppler estimation, signal detection, correlation, channel estimation),
   physical sensor measurements (e.g., temperature, speedometer, pressure, etc.),
   map, mapping function, table, location (e.g., to find environment information based on a radio environment map and given location, to match measurement results to environment information using a table relation or mapping function)
   historical data, statistics, observation data (e.g., determine typical environment information from historical data or based on collected statistics for a given area);
Determining the environment information based on a message or indication received from another node (e.g., OAM or other network node, etc.) via unicast/multicast/broadcast, upon a request from the first node or in an unsolicited manner.
Determining or building the environment information (e.g., environment knowledge or map), based on one or more sensing results (e.g., a first node, which could be a UE, determined an obstacle and indicates this to the second node, which could a network node).
Determining or building the environment information (e.g., environment knowledge or map), based on one or more sensing results, jointly with another radio node (e.g., the second node, UE, network node, sensing unit, etc.)
   In one example, the joint determining may comprise environment verification:
      The first node obtains one or more sensing results (e.g., determining an obstacle nearby).
      The first node may further request the other node to verify if the sensing result it obtained is correct. The other node may verify against its available environment knowledge or a map or it may perform sensing in the same direction as the first node.
      The other node may provide a positive ack or negative ack, based on its verification result.
   In another example, the joint determining may comprise complementary sensing, e.g.:
      The first node may perform sensing over a first part of the environment to be determined, e.g., via direction/angle 0 to 180 degree.
      The other node (e.g., the second node, another UE, sensing unit, or a network node) may perform sensing between 180 to 360 degrees with the first node as reference (origin).
      The first node and the other node may coordinate with each other, e.g., share the results, divide the responsibility determining the parts of the environment to be determined by each of them, combine the results into environment information, e.g., based on union/aggregation/merging of the individual results.
      In some cases, both the first node and the other node may perform sensing in the same direction and the results can be compared for any differences or combined based on rules.

The obtaining of the environment information can be, e.g., upon a request from another node or in an unsolicited way, upon a triggering condition (e.g., an event detected which may impact the environment information), periodic with some pre-defined or configured periodicity, etc.

The sensing target can be, e.g., provided to the first node in a message by another node, obtained from a higher layer in the first node, determined by the first node, indicated by the first node to another node in relation to sensing, etc.

In one embodiment, the environment information comprises, e.g., at least one of:
Environment type (e.g., indoor/outdoor, aquatic/terrestrial/atmospheric, rural/suburban/urban/dense urban, static/dynamic/moving, industrial zone, office, home, road, tunnel, single-floor/multi-floor, weather or air condition, surface condition, material type of obstacles or sensing target, etc.)
Radio environment quality (i.e sensing radio quality of the environment) is, bad, difficult, not bad, easy, mixed, etc.)
Radio propagation characteristics (e.g., LOS, NLOS, fading characteristics, multipath structure, rich or heavy multipath, light multipath, uniform/mixed propagation environment, etc.)
Knowledge level about the environment (e.g., well-known, known, unknown, etc.)
Environment information quality or reliability level (e.g., reliable, roughly estimated, expected, guessed, number of reports/samples/measurements used, confidence interval or confidence level or uncertainty of an estimated environment characteristic, etc.)
Environment information actuality (e.g., old, new, on-line, up-to-date, not up-to-date, likely up-to-date, obtained within time X, etc.)
Speed of the sensing target or the first node (e.g., low, medium, high, Y km/h, etc.)
Velocity or movement direction of the sensing target or the first node
Statistical characteristic, statistical data or a function of one or more environment information parameter or characteristic listed above (e.g., average, median, minimum, maximum, distribution function, PDF, CDF, one or more percentile levels such as X1 at 5%-ile and x2 at 95%-ile, sum, weighted sum, standard deviation, etc.)

The environment can be further associated with a sensing target or sensing area.

The environment information may further additionally comprise, e.g.:
Location information (e.g., 2D location, 3D location, height, floor level, an encoded location area, a map associated with the assistance information, etc.)
Time (of the day, week, year, etc.) associated with the environment information, e.g., for which the environment information applies, over which the information was collected, time stamp of the environment information report, etc.
Validity time, e.g., for how long the information is valid or when it may need to be updated

The environment information can be, e.g.
Absolute
Relative with respect to a reference or the previous environment information (e.g., same, different/changed, an amount Delta indicative of a relative change, etc.)

### 3.3 Step 204: Providing the Environment Information to a Second Node

The first node provides the environment information to the second node (e.g., another UE or a network node).
In some examples, the providing further comprises sending a parameter value, an indicator encoding the environment information (e.g., ‘0’ corresponding to a first environment type, ‘1’ corresponding to a second environment type, etc.), a structure or a sequence comprising elements describing different environment parameters and characteristics.
In some examples, the providing is via direct link (e.g., Radio Resource Control (RRC) protocol or X2 interface) or via one or more other nodes (e.g., sensing protocol going between first and second nodes transparently via BS).
In some examples, the providing is via low-layer signaling (e.g., L1 signaling) or higher-layer signaling (e.g., L2 or L3 signaling).
In some examples, the providing is upon a request from the second node or in an unsolicited way, upon a triggering condition (e.g., a change in environment information occurred), or periodic with some periodicity (e.g., pre-defined or configured).
In some examples, the providing further comprises:
   a check for any change in the environment information compared to the previously provided environment information, and
   providing the environment information if a change has been determined during the check (in which case, in one example, the first node may provide all environment information; and in another example, the first node may selectively provide only the changed parts of the environment information).

In some further examples, the environment information is provided in any of:
sensing request,
sensing result request,
sensing assistance information,
sensing configuration message,
sensing “provide information” message,
sensing “validating request” message,
sensing “aggregated or differential result” message

Examples of the first and second nodes (see Section 1 above for the terms “network node” or “UE”) include:
UE→network node
First UE→second UE
First network node→second network node
Network node→UE

In some examples, the first node further comprises a Sensing Client, which is triggering a sensing request.

In some examples, the first node further receives a confirmation or acknowledgement from the second node of reception of an indication or message comprising environment information from the first node (the indication or message may or may not comprise other information, in addition to the environment information).

### 3.4 Step 206: Receiving a Sensing Result

This step does not need to be present in all implementations.

The first node is receiving a sensing result from another node (e.g., the second node), in response to the message comprising the environment information.

An example: A UE or a sensing client receives a sensing result from a network node, sensing management function or sensing server in response to the message comprising environment information.

Different first nodes may receive different sensing results, if they provide different environment information, even for the same sensing area.

In one embodiment, the sensing result (see Section 1 above for sensing result definition) comprises, e.g., one or more of:
Sensing measurements (see Section 1 above for sensing measurement definition),
A result of processing sensing measurements to achieve a sensing purpose (see Section 1 for sensing purpose definition).

### 4 Methods in a Second Node

Embodiments of a method in the second node (e.g., a network node, sensing management function or sensing server, sensing unit, etc.) are also disclosed. As illustrated in FIG. 3, the method in the second node comprises the following:
Step 300: The second node obtains the environment information (e.g., from the first node as in, e.g., steps 200 and 204).
   In some examples, the obtaining further comprises receiving the environment information from the first node (see Section 3 above) or from another network node, sensing management function or sensing server, sensing unit, etc.
   In some examples, the obtaining further comprises sending to the first node a confirmation or acknowledgement of reception of an indication or message comprising environment information from the first node (the indication or message may or may not comprise other information, in addition to the environment information).
Step 302: The second node uses the environment information for radio-signal based sensing (e.g., choosing or configuring one or more parameters for a sensing session, configuring sensing units, providing the obtained sensing information to one or more sensing units, etc.).
Step 304 (in some, but not necessarily all, embodiments): The second node provides a sensing result to a third node (e.g., UE, sensing client, or another network node), wherein the sensing result is based on the said environment information.

See Section 1 above for the terms “sensing client”, “sensing server”, “network node”, and “UE”. Further details regarding each of the steps of the method of FIG. 3 are provided in the sub-sections below.

### 4.1 Step 1: Obtaining the Environment Information

The second node (e.g., network node) obtains the information about the environment of a sensing target (e.g., an area or an object), e.g., by one or more of:
Determining the environment information based on any one or more of:
   radio measurements or channel estimation result (e.g., determining radio propagation characteristics, link quality, velocity data, single or multiple peak detection, or location based on pathloss estimation, LOS/NLOS detection, timing measurements, angle measurements, received power measurements, doppler estimation, signal detection, correlation, channel estimation),
   physical sensor measurements (e.g., temperature, speedometer, pressure, . . . ) ,
   map, mapping function, table, location (e.g., to find environment information based on a radio environment map and given location, to match measurement results to environment information using a table relation or mapping function)
   historical data, statistics, observation data (e.g., determine typical environment information from historical data or based on collected statistics for a given area);
Determining the environment information based on a message or indication received from another node (e.g., from a first node—see Section 3) via unicast/multicast/broadcast, upon a request from the first node or in an unsolicited manner.
   In some examples, the second node further sends to the first node a confirmation or acknowledgement of reception of an indication or message comprising environment information from the first node (the indication or message may or may not comprise other information, in addition to the environment information).

### 4.2 Step 2: Using the Said Environment Information for Radio-Signal Based Sensing

The second node uses the environment information for radio-signal based sensing, e.g., based on the obtained in the previous step environment information do any one or more of the below:
configuring one or more parameters for a sensing session, configuring sensing units, providing the obtained sensing information to one or more sensing units, etc.
Choose a configuration
   Selecting a set of nodes for transmitting radio signals for the sensing
   Selecting a set of nodes for receiving radio signals for the sensing
   Configuring at least one radio signal to be transmitted for the sensing (e.g., configure radio signal type, transmit power, time and/or frequency resources or pattern for the radio signal, periodicity, number of symbols, bandwidth, number of transmit occasions, number of slots, etc.)
      A larger bandwidth, higher power, more symbols/slots/transmit occasions, shorter periodicity may be needed for a sensing measurement in “more difficult” environments (e.g., NLOS, rich multipath, larger distances, high Doppler, etc.)
   Choosing an antenna configuration (e.g., number or a set of tx beams, number or a set of rx beams, directions. etc.) based on the environment information
   Selecting and/or configuring a set of distributed antennas or radio units
   Configuring transmit power for at least one radio signal for sensing
   Configuring at least one sensing measurement
In some examples, the environment information or the chosen configuration based on the environment information is further sent to another node (e.g., sensing units), e.g., to configure the node accordingly or to provide the assistance information for a sensing procedure (e.g., transmitting radio signals for sensing and/or receiving radio signals for sensing depending upon sensing quality).
Obtain at least one sensing result or sensing measurement result, e.g., by performing sensing measurements, processing sensing measurements, or receiving sensing measurements or sensing result from another node (e.g., the earlier configured node according to the above, from a sensing unit, etc.).

### 4.3 Step 3: Providing a Sensing Result (in Some Embodiments)

This step does not need to be present in all implementations.

An example: A network node sends a sensing result to a UE or another network node (e.g., sensing management function, SeMF, sensing server, sensing client, OAM, positioning node, ESMLC, or another network node) in response to receiving a message comprising environment information.

The sensing result (see Section 1 for the definition of sensing result, sensing measurement, sensing purpose, etc.) may comprise, e.g., one or more of:
Sensing measurements,
A result of processing sensing measurements to achieve sensing purpose

### 5 Further Description

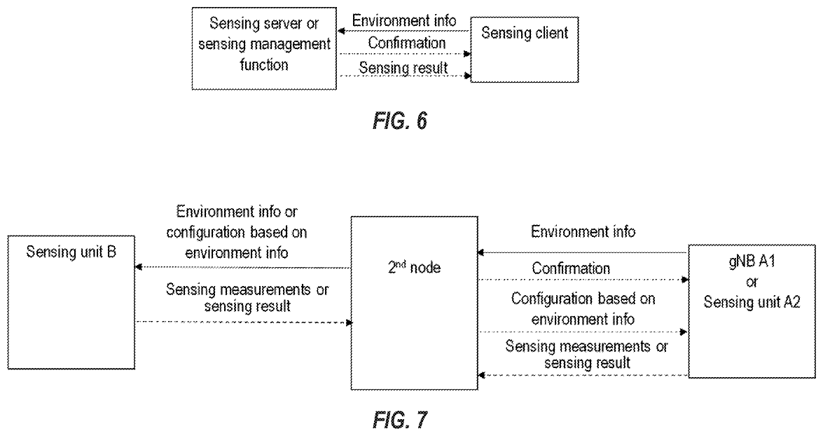

FIG. 9 shows an example of a communication system 900 in accordance with some embodiments.

In the example, the communication system 900 includes a telecommunication network 902 that includes an access network 904, such as a Radio Access Network (RAN), and a core network 906, which includes one or more core network nodes 908. The access network 904 includes one or more access network nodes, such as network nodes 910A and 910B (one or more of which may be generally referred to as network nodes 910), or any other similar Third Generation Partnership Project (3GPP) access node or non-3GPP Access Point (AP). The network nodes 910 facilitate direct or indirect connection of User Equipment (UE), such as by connecting UEs 912A, 912B, 912C, and 912D (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system 900 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 902 is a cellular network that implements 3GPP standardized features. Accordingly, the telecommunication network 902 may support network slicing to provide different logical networks to different devices that are connected to the telecommunication network 902. For example, the telecommunication network 902 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single-or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 914 communicates with the access network 904 to facilitate indirect communication between one or more UEs (e.g., UE 912C and/or 912D) and network nodes (e.g., network node 910B). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a Virtual Reality (VR) headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910B. The hub 914 may also allow for a different communication scheme and/or schedule between the hub 914 and UEs (e.g., UE 912C and/or 912D), and between the hub 914 and the core network 906. In other examples, the hub 914 is connected to the core network 906 and/or one or more UEs via a wired connection. Moreover, the hub 914 may be configured to connect to a Machine-to-Machine (M2M) service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub-that is, a hub whose primary function is to route communications to/from the UEs from/to the network node 910B. In other embodiments, the hub 914 may be a non-dedicated hub—that is, a device which is capable of operating to route communications between the UEs and the network node 910B, but which is additionally capable of operating as a communication start and/or end point for certain data channels.

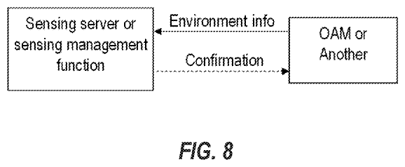

FIG. 10 shows a UE 1000 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1002 may include multiple Central Processing Units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging the power source 1008. Power circuitry may perform any formatting, converting, or other modification to the power from the power source 1008 to make the power suitable for the respective components of the UE 1000 to which power is supplied.

The memory 1010 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1010 may allow the UE 1000 to access instructions, application programs, and the like stored on transitory or non-transitory memory media, to off-load data, or to upload data. An article of manufacture, such as one utilizing a communication system, may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., the antenna 1022) and may share circuit components, software, or firmware, or alternatively be implemented separately.

In the illustrated embodiment, communication functions of the communication interface 1012 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1012, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

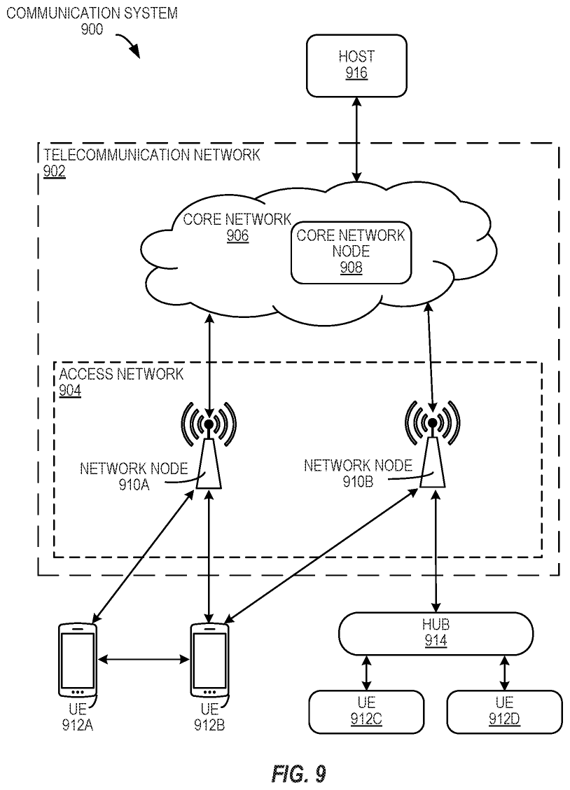

FIG. 11 shows a network node 1100 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes processing circuitry 1102, memory 1104, a communication interface 1106, and a power source 1108. The network node 1100 may be composed of multiple physically separate components (e.g., a Node B component and an RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1100 may be configured to support multiple RATs. In such embodiments, some components may be duplicated (e.g., separate memory 1104 for different RATs) and some components may be reused (e.g., an antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1100.

The processing circuitry 1102 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1100 components, such as the memory 1104, to provide network node 1100 functionality.

In some embodiments, the processing circuitry 1102 includes a System on a Chip (SOC). In some embodiments, the processing circuitry 1102 includes one or more of Radio Frequency (RF) transceiver circuitry 1112 and baseband processing circuitry 1114. In some embodiments, the RF transceiver circuitry 1112 and the baseband processing circuitry 1114 may be on separate chips (or sets of chips), boards, or units, such as radio units and digital units. In alternative embodiments, part or all of the RF transceiver circuitry 1112 and the baseband processing circuitry 1114 may be on the same chip or set of chips, boards, or units.

The memory 1104 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and the memory 1104 are integrated.

£ The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. The radio front-end circuitry 1118 comprises filters 1120 and amplifiers 1122. The radio front-end circuitry 1118 may be connected to the antenna 1110 and the processing circuitry 1102. The radio front-end circuitry 1118 may be configured to condition signals communicated between the antenna 1110 and the processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of the filters 1120 and/or the amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface 1106 may comprise different components and/or different combinations of components.

In certain alternative embodiments, the network node 1100 does not include separate radio front-end circuitry 1118; instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes the one or more ports or terminals 1116, the radio front-end circuitry 1118, and the RF transceiver circuitry 1112 as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, the communication interface 1106, and/or the processing circuitry 1102 may be configured to perform any receiving operations and/or certain obtaining operations described herein as being performed by the network node 1100. Any information, data, and/or signals may be received from a UE, another network node, and/or any other network equipment. Similarly, the antenna 1110, the communication interface 1106, and/or the processing circuitry 1102 may be configured to perform any transmitting operations described herein as being performed by the network node 1100. Any information, data, and/or signals may be transmitted to a UE, another network node, and/or any other network equipment.

The power source 1108 provides power to the various components of the network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid or an electricity outlet) via input circuitry or an interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

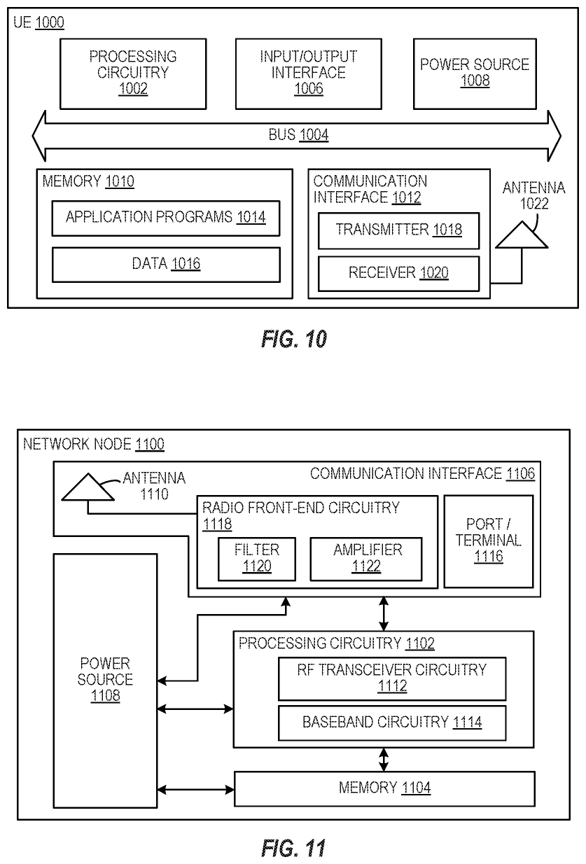

FIG. 12 is a block diagram of a host 1200, which may be an embodiment of the host 916 of FIG. 9, in accordance with various aspects described herein. As used herein, the host 1200 may be or comprise various combinations of hardware and/or software including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and memory 1212. Other components may be included in other embodiments. Features of these components may be substantially similar to those described with respect to the devices of previous figures, such as FIGS. 10 and 11, such that the descriptions thereof are generally applicable to the corresponding components of the host 1200.

The memory 1212 may include one or more computer programs including one or more host application programs 1214 and data 1216, which may include user data, e.g. data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for Over-The-Top (OTT) services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

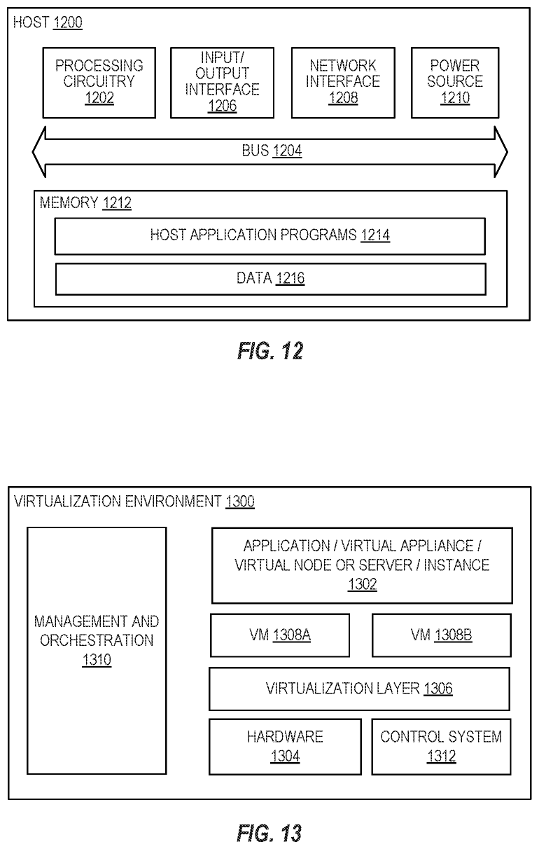

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or VM Monitors (VMMs)), provide VMs 1308A and 1308B (one or more of which may be generally referred to as VMs 1308), and/or perform any of the functions, features, and/or benefits described in relation with some embodiments described herein. The virtualization layer 1306 may present a virtual operating platform that appears like networking hardware to the VMs 1308.

The VMs 1308 comprise virtual processing, virtual memory, virtual networking, or interface and virtual storage, and may be run by a corresponding virtualization layer 1306. Different embodiments of the instance of a virtual appliance 1302 may be implemented on one or more of the VMs 1308, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1308 may be a software implementation of a physical machine that runs programs as if they were executing on a physical, non-virtualized machine.

Each of the VMs 1308, and that part of the hardware 1304 that executes that VM, be it hardware dedicated to that VM and/or hardware shared by that VM with others of the VMs 1308, forms separate virtual network elements. Still in the context of NFV, a virtual network function is responsible for handling specific network functions that run in one or more VMs 1308 on top of the hardware 1304 and corresponds to the application 1302.

The hardware 1304 may be implemented in a standalone network node with generic or specific components. The hardware 1304 may implement some functions via virtualization. Alternatively, the hardware 1304 may be part of a larger cluster of hardware (e.g., such as in a data center or CPE) where many hardware nodes work together and are managed via management and orchestration 1310, which, among others, oversees lifecycle management of the applications 1302. In some embodiments, the hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1312 which may alternatively be used for communication between hardware nodes and radio units.

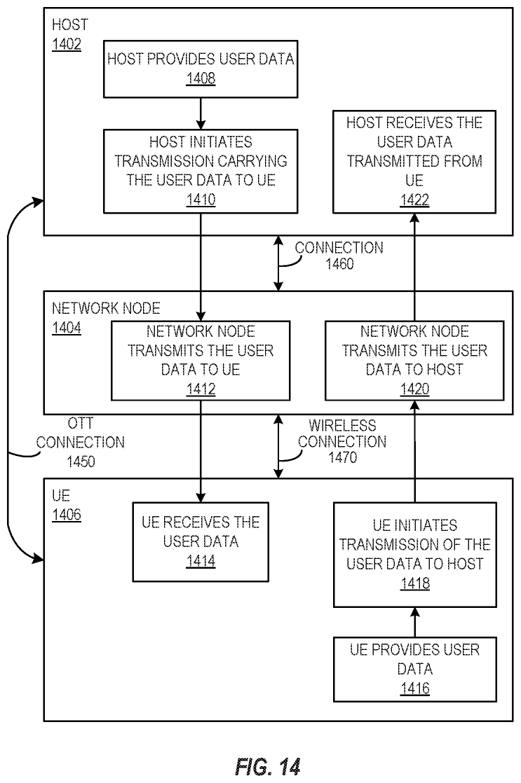

FIG. 14 shows a communication diagram of a host 1402 communicating via a network node 1404 with a UE 1406 over a partially wireless connection in accordance with some embodiments. Example implementations, in accordance with various embodiments, of the UE (such as the UE 912A of FIG. 9 and/or the UE 1000 of FIG. 10), the network node (such as the network node 910A of FIG. 9 and/or the network node 1100 of FIG. 11), and the host (such as the host 916 of FIG. 9 and/or the host 1200 of FIG. 12) discussed in the preceding paragraphs will now be described with reference to FIG. 14.

Like the host 1200, embodiments of the host 1402 include hardware, such as a communication interface, processing circuitry, and memory. The host 1402 also includes software, which is stored in or is accessible by the host 1402 and executable by the processing circuitry. The software includes a host application that may be operable to provide a service to a remote user, such as the UE 1406 connecting via an OTT connection 1450 extending between the UE 1406 and the host 1402. In providing the service to the remote user, a host application may provide user data which is transmitted using the OTT connection 1450.

The network node 1404 includes hardware enabling it to communicate with the host 1402 and the UE 1406 via a connection 1460. The connection 1460 may be direct or pass through a core network (like the core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by the UE 1406 and executable by the UE's processing circuitry. The software includes a client application, such as a web browser or operator-specific “app” that may be operable to provide a service to a human or non-human user via the UE 1406 with the support of the host 1402. In the host 1402, an executing host application may communicate with the executing client application via the OTT connection 1450 terminating at the UE 1406 and the host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via the connection 1460 between the host 1402 and the network node 1404 and via a wireless connection 1470 between the network node 1404 and the UE 1406 to provide the connection between the host 1402 and the UE 1406. The connection 1460 and the wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404 in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR, or AR which it can broadcast, multicast, or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1450 between the host 1402 and the UE 1406 in response to variations in the measurement results. The measurement procedure and/or the network functionality for reconfiguring the OTT connection 1450 may be implemented in software and hardware of the host 1402 and/or the UE 1406. In some embodiments, sensors (not shown) may be deployed in or in association with other devices through which the OTT connection 1450 passes; the sensors may participate in the measurement procedure by supplying values of the monitored quantities exemplified above, or by supplying values of other physical quantities from which software may compute or estimate the monitored quantities. The reconfiguring of the OTT connection 1450 may include message format, retransmission settings, preferred routing, etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency, and the like by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some exemplary embodiments of the present disclosure are as follows:
Embodiment 1: A method performed by a first node, the method comprising: obtaining (202) environment information; and providing (204) the environment information to a second node associated with sensing or involved in a sensing session.
Embodiment 2: The method of embodiment 1 wherein the environment information is information about an environment associated with the first node.
Embodiment 3: The method of embodiment 2 wherein the environment is a physical environment, a radio environment for sensing, or a combination both the physical environment and the radio environment.
Embodiment 4: The method of any of embodiments 1 to 3 wherein the environment information comprises: (a) environment type; (b) sensing radio environment quality; (c) sensing radio propagation characteristics; (d) knowledge level about the environment; (e) environment information quality or reliability level; (f) environment information actuality; (g) speed; (h) velocity or movement direction; (i) statistical characteristic, statistical data or a function of one or more environment information parameter or characteristic listed above; or (j) a combination of any two or more of (a)-(i).
Embodiment 5: The method of embodiment 4 wherein the environment is associated with a sensing target or sensing area.
Embodiment 6: The method of embodiment 4 or 5 wherein the environment information further comprises one or more of the following: (i) location information; (ii) time associated with the environment information, e.g., for which the environment information applies, over which the information was collected, time stamp of the environment information report, etc.; (iii) validity time, e.g., for how long the information is valid or when it may need to be updated; or (iv) a combination of any two or more of (i)-(iii):
Embodiment 7: The method of any of embodiments 1 to 6 wherein obtaining (202) environment information comprises one or more of the following:
   A. determining the environment information based on any one or more of:
      I. radio measurements or channel estimation result,
      II. physical sensor measurements,
      III. map, mapping function, table, location,
      IV. historical data, statistics, observation data, or
      V. a combination of any two or more of I-IV;
   B. determining the environment information based on a message or indication received from another node (e.g., via unicast/multicast/broadcast, upon a request from the first node or in an unsolicited manner);
   C. determining or building the environment information (e.g., environment knowledge or map), based on one or more sensing results;
   D. determining or building the environment information (e.g., environment knowledge or map), based on one or more sensing results, jointly with another radio node (e.g., the second node, UE, network node, sensing unit, etc.); or
   E. a combination of any two or more of A-D.
Embodiment 8: The method of any of embodiments 1 to 7 wherein providing (204) the environment information to the second node comprises providing (204) the environment information to the second node via a sensing request, a sensing result request, sensing assistance information, a sensing configuration message, a provide information message associated to sensing, a validate request associated to sensing, or an aggregated or differential result message associated to sensing.
Embodiment 9: The method of any of embodiments 1 to 8 further comprising receiving (200) a request from the environment information from the second node.
Embodiment 10: The method of any of embodiments 1 to 9 further comprising receiving (206) one or more sensing results from another node, in response to providing (204) the environment information to the second node.
Embodiment 11: The method of any of embodiments 1 to 10 wherein the first node is a User Equipment, UE, and the second node is a network node.
Embodiment 12: The method of any of embodiments 1 to 10 wherein the first node is a first User Equipment, UE, and the second node is a second UE.
Embodiment 13: The method of any of embodiments 1 to 10 wherein the first node is a first network node and the second node is a second network node.
Embodiment 14: The method of any of embodiments 1 to 10 wherein the first node is a network node and the second node is a User Equipment, UE.
Embodiment 15: A first node adapted to perform the method of any of embodiments 1 to 14.
Embodiment 16: A method performed by a second node, the method comprising: obtaining (300) environment information; and using (302) the environment information for radio-signal based sensing.
Embodiment 17: The method of embodiment 1 wherein the environment information is information about an environment associated with the second node and/or a first node.
Embodiment 18: The method of embodiment 17 wherein the environment is a physical environment, a radio environment, or a combination both the physical environment and the radio environment.
Embodiment 19: The method of any of embodiments 16 to 18 wherein the environment information comprises: (a) environment type; (b) radio environment quality; (c) radio propagation characteristics; (d) knowledge level about the environment; (e) environment information quality or reliability level; (f) environment information actuality; (g) speed; (h) velocity or movement direction; (i) statistical characteristic, statistical data or a function of one or more environment information parameter or characteristic listed above; or (j) a combination of any two or more of (a)-(i).
Embodiment 20: The method of embodiment 19 wherein the environment is associated with a sensing target or sensing area.
Embodiment 21: The method of embodiment 19 or 20 wherein the environment information further comprises one or more of the following: (i) location information; (ii) time associated with the environment information, e.g., for which the environment information applies, over which the information was collected, time stamp of the environment information report, etc.; (iii) validity time, e.g., for how long the information is valid or when it may need to be updated; or (iv) a combination of any two or more of (i)-(iii):
Embodiment 22: The method of any of embodiments 16 to 21 wherein obtaining (300) the environment information comprises receiving the environment information from another node.
Embodiment 23: The method of embodiment 22 wherein the another node is a first node.
Embodiment 24: The method of embodiment 22 wherein the another node is a network node, a sensing management function, a sensing server, or a sensing unit.
Embodiment 25: The method of any of embodiments 16 to 21wherein obtaining (300) the environment information comprises one or more of the following:
   A. determining the environment information based on any one or more of:
      I. radio measurements or channel estimation result,
      II. physical sensor measurements,
      III. map, mapping function, table, location,
      IV. historical data, statistics, observation data, or
      V. a combination of any two or more of I-IV;
   B. determining the environment information based on a message or indication received from another node (e.g., via unicast/multicast/broadcast, upon a request from the first node or in an unsolicited manner); or
   C. a combination of A and B.
Embodiment 26: The method of any of embodiments 16 to 25 wherein using (302) the environment information for radio-signal based sensing comprises:
   (1) configuring one or more parameters for a sensing session based on the environment information;
   (2) configuring one or more sensing units based on the environment information;
   (3) providing the environment information to one or more sensing units;
   (4) choosing one or more configurations for sensing, based on the environment information, wherein choosing the one or more configurations for sensing comprises:
      selecting a set of nodes for transmitting radio signals for the sensing;
      selecting a set of nodes for receiving radio signals for the sensing;
      configuring at least one radio signal to be transmitted for the sensing
      choosing an antenna configuration;
      selecting and/or configuring a set of distributed antennas or radio units;
      configuring transmit power for at least one radio signal for sensing;
      configuring at least one sensing measurement; or
      a combination of any two or more thereof;
   (5) sending the environment information or a chosen configuration based on the environment information to another node;
   (6) obtaining at least one sensing result or sensing measurement result; or
   (7) a combination of any two or more of (1)-(6).
Embodiment 27: The method of any of embodiments 16 to 26 further comprising providing (304) a sensing result to another node.
Embodiment 28: The method of any of embodiments 16 to 27 wherein the second node is a network node.
Embodiment 29: The method of any of embodiments 16 to 27 wherein the second node is a first User Equipment, UE.
Embodiment 30: A second node adapted to perform the method of any of embodiments 16 to 29.

Those skilled in the art will recognize improvements and modifications to the embodiments of the present disclosure. All such improvements and modifications are considered within the scope of the concepts disclosed herein.

1. A method performed by a first node for conveying environmental information to assist in radio-signal-based sensing using a cellular network, the method comprising:
obtaining environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object; and
providing the environment information to a second node associated with the radio-signal-based sensing or involved in a radio-signal-based sensing session.

2. The method of claim 1, wherein the environment associated to the sensing target or sensing area is an environment associated with the first node.

3. The method of claim 1, wherein the sensing object is an object that is not connected to the cellular network.

4. The method of claim 1, wherein the environment information comprises location information of the first node.

5. The method of claim 1, wherein the environment information comprises:
(a) environment type;
(b) sensing radio environment quality;
(c) radio propagation characteristics;
(d) knowledge level about the environment;
(e) environment information quality or reliability level;
(f) environment information actuality;
(g) speed of the sensing target or the first node;
(h) velocity or movement direction of the sensing target or the first node;
(i) statistical characteristic, statistical data or a function of one or more environment information parameters or characteristics listed in (a)-(h); or
(j) a combination of any two or more of (a)-(i).

6. The method of claim 5, wherein the environment information further comprises one or more of the following:
(i) location information about a location of the environment associated to the sensing target or sensing area;
(ii) time associated with the environment information;
(iii) validity time for the environment information; or (iv) a combination of any two or more of (i)-(iii).

7. The method of claim 1, wherein obtaining environment information comprises determining the environment information based on any one or more of: radio measurements, radio channel estimation result, physical sensor measurements, a map, a mapping function, a table, a location, historical data, statistics, observation data, or a combination of any two or more thereof.

8. (canceled)

9. The method of claim 1, wherein obtaining environment information comprises determining the environment information based on a message or indication received from another node.

10. The method of claim 1, wherein obtaining environment information comprises determining or building the environment information, based on one or more sensing results either alone or jointly with another radio node.

11. (canceled)

12. The method of claim 1, wherein obtaining environment information comprises determining or building the environment information, based on one or more sensing results jointly with another radio node, and determining or building the environment information, based on one or more sensing results, jointly with another radio node, comprises:
performing sensing over a first part of the environment to thereby obtain sensing results for the first part of the environment;
receiving sensing results for a second part of the environment from a second node; and
combining the sensing results for the first part of the environment and the sensing result received from the second node for the second part of the environment to provide the environment information.

13. The method of claim 1, wherein obtaining environment information comprises determining or building the environment information, based on one or more sensing results jointly with another radio node, and determining or building the environment information, based on one or more sensing results, jointly with another radio node, comprises requesting that a second node verify the environment information.

14. The method of claim 1, wherein providing the environment information to the second node comprises providing the environment information to the second node via a sensing request, a sensing result request, a response to a sensing-related request or configuration message from the second node, sensing assistance information, a sensing configuration message, an information message associated to sensing, a validate request associated to sensing, or an aggregated or differential result message associated to sensing.

15-16. (canceled)

17. The method of claim 1, wherein:
the first node is a User Equipment (UE), the second node is a network node, and the environment is an environment of the UE; or
the first node is a first UE, the second node is a second UE, and the environment is an environment of the first UE; or
the first node is a first network node and the second node is a second network node; or
the first node is a network node and the second node is a UE.

18-22. (canceled)

23. The method of claim 1, wherein the first node comprises a sensing client or sensing application.

24. The method of claim 1, wherein the first node comprises a sensing unit further comprising one or both of: transmitter transmitting a radio signal for sensing and receiver receiving a radio signal for sensing or performing a sensing measurement.

25-26. (canceled)

27. A first node for conveying environmental information to assist in radio-signal-based sensing using a cellular network, the first node comprising processing circuitry configured to cause the first node to:
obtain environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object; and
provide the environment information to a second node associated with the radio-signal-based sensing or involved in a radio-signal-based sensing session.

28. (canceled)

29. A method performed by a second node for radio-signal-based sensing using a cellular network, the method comprising:
obtaining, from a first node, environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object; and
using the environment information for radio-signal based sensing of the sensing target or sensing area.

30-34. (canceled)

35. The method of claim 29, wherein using the environment information for radio-signal based sensing comprises:
I. configuring one or more parameters for a sensing session based on the environment information;
II. configuring one or more sensing units based on the environment information;
III. providing the environment information to one or more sensing units;
IV. choosing one or more configurations for sensing, based on the environment information, wherein choosing the one or more configurations for sensing comprises:
selecting a set of nodes for transmitting radio signals for the sensing;
selecting a set of nodes for receiving radio signals for the sensing;
configuring at least one radio signal to be transmitted for the sensing
choosing an antenna configuration;
selecting and/or configuring a set of distributed antennas or radio units;
configuring transmit power for at least one radio signal for sensing;
configuring at least one sensing measurement; or
a combination of any two or more thereof;
V. sending the environment information or a chosen configuration based on the environment information to another node;
VI. obtaining at least one sensing result or sensing measurement result; or
VII. a combination of any two or more of I-VI.

36. (canceled)

37. The method of claim 29, wherein the second node is a network node or the second node is a first User Equipment (UE).

38-40. (canceled)

41. A second node for radio-signal-based sensing using a cellular network, the second node comprising processing circuitry configured to cause the second node to:
obtain, from a first node, environment information about an environment associated to a sensing target or sensing area for radio-signal-based sensing using a cellular network, the environment being a physical environment of the sensing target or sensing object, a radio environment of the sensing target or sensing object, or both the physical environment and radio environment of the sensing target or sensing object; and
use the environment information for radio-signal based sensing of the sensing target or sensing area.

42. (canceled)
